(19) United States
(12) Patent Application Publication
(10) Pub. No.: US 2017/0109340 A1
(43) Pub. Date: Apr. 20, 2017

(54) PERSONALIZING TEXT BASED UPON A TARGET AUDIENCE

(71) Applicant: International Business Machines Corporation, Armonk, NY (US)

(72) Inventors: Jilin Chen, Sunnyvale, CA (US); Richard P. Gabriel, San Jose, CA (US); Jeffrey W. Nichols, San Jose, CA (US)

(73) Assignee: International Business Machines Corporation, Armonk, NY (US)

(21) Appl. No.: 14/886,393

(22) Filed: Oct. 19, 2015

(51) Int. Cl. G06F 17/24; G06F 17/27; G06F 17/22; G06F 17/30; G06F 3/0482

(52) U.S. Cl. CPC G06F 17/248; G06F 17/3053; G06F 17/241; G06F 3/0482; G06F 17/2288; G06F 17/2785

(57) ABSTRACT

Provided are techniques for tailoring correspondence based upon individual recipients, comprising receiving a correspondence for dissemination to a set of recipients; annotating text within the composition to identify words and characteristics of the words; identifying a customization criteria based upon a target audience; generating, a template, wherein the template comprises: the customization criteria; and modification constraints; and applying the template and the customization criteria to the annotated text to generate a revised correspondence.

### FIELD OF DISCLOSURE

The claimed subject matter relates generally to the customization of text and, more specifically, to techniques for automatically revising a textual composition based upon a target audience.

### BACKGROUND OF THE INVENTION

Writers and organizations may desire to deliver a communication or message to hundreds, thousands or even millions of people. Although groups of people may include many different target audiences, with each audience associated with a corresponding demographic. Such communications can be more effective if they are customized for each particular target audience. However, it may not be cost effective to customize a message for more than a handful of different demographics of the target audience.

Examples of sources of data that may facilitate better and better targeted writing include dictionaries, synonym dictionaries, phonetic dictionaries, stem dictionaries and linguistic inquiry and word count (LIWC) dictionaries. One basis for the analysis of a composition is the concept of n-grams. According to the Wikipedia Foundation of San Francisco, Calif., in the fields of computational linguistics and probability, an n-gram is a contiguous sequence of n items from a given sequence of text or speech. The items may be phonemes, syllables, letters, words or base pairs accord mg to the application.

### SUMMARY

Provided is a Composition Revision Engine (CRE) that incorporates techniques for natural language revision in a textual composition. CRE is designed to assist writers by producing stylistic variations on the textual composition based on craft-based facets of creative writing and by mimicking, or avoiding, aspects of specified writers and their personality traits. Included with CRE is an optimization module that produces variations on the text of the composition, evaluates those variations quantitatively, and selects variations that best satisfy the goals of writing craft and writer mimicry, or avoidance,

In one embodiment, CRE generates a variety of revisions of a given composition using a synonym dictionary that includes glosses (dictionary definition text) and a wide variety of soft constraints or “influences,” Constraints may embody the kinds of thinking a poet or fiction writer might employ, such as, but not limited to, the music of the words (the so-called sound, or “noise,” that language makes when spoken), subtexts and moods, subtle semantic differences created by the influence of a set of words, a detailed language-usage model, accurate semantic senses, orthographic characteristics of words, and the notion of a spectrum from very associative word choices to very dissociative.

Provided are techniques for tailoring correspondence based upon individual recipients, comprising receiving a correspondence for dissemination to a set of recipients; annotating text within the composition to identify words and characteristics of the words; identifying a customization criteria, wherein the customization criteria is based upon a writing style and exhibited personality characteristics of a writer of the correspondence and a target audience in the set of recipients; generating a template, wherein the template comprises: the customization criteria; and modification constraints; applying the template and the customization criteria to the annotated text to generate a revised correspondence; and transmitting the revised correspondence to the target audience.

This summary is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed description.

### BRIEF DESCRIPTION OF THE DRAWINGS

A better understanding of the claimed subject matter can be obtained when the following, detailed description of the disclosed embodiments is considered in conjunction with the following figures, in which:

FIG. 1 is a block diagram of a computing block diagram of a computing architecture that may support the claimed subject matter.

FIG. 2 is a block diagram of an example of a Creative Revision Engine (CRE), first introduced in FIG. 1, that may implement the claimed subject matter.

FIG. 3 is a flowchart of a Generate Template process that may implement aspects of the claimed subject matter.

FIG. 4 is a flowchart of a Modify Composition that may implement aspects of the claimed subject matter.

FIG. 5 is an illustration of a Template input Pane that may implement aspects of the claimed subject matter.

FIG. 6 is an illustration of a Bonus Pane that may implement aspects of the claimed subject matter.

FIG. 7 is an illustration of a Synonym Selection Pane that may implement aspects of the claimed subject matter.

FIG. 8 is an illustration of a Sense Selection Pane that may implement aspects of the claimed subject matter.

FIG. 9 is an illustration of a Present Pane that may implement aspects of the claimed subject matter.

FIG. 10 is an illustration of a Synonym Grapher Pane that may implement aspects of the claimed subject matter.

FIG. 11 is an illustration or an Annotation Helper Pane that may implement aspects of the claimed subject matter.

FIG. 12 is an illustration of another Annotation Helper Pane that may implement aspects of the claimed subject matter.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through as fiber-optic cable), or electrical signals transmitted through a wire.

Computer readable program instructions described herein can be downloaded to respective computing/processing devices from a computer readable storage medium or to an external computer or external storage device via as network, for example, the Internet, as local area network, a wide area network and/or a wireless network. The network, may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages any functional programming languages such as Lisp, Haskell and the like. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) in some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

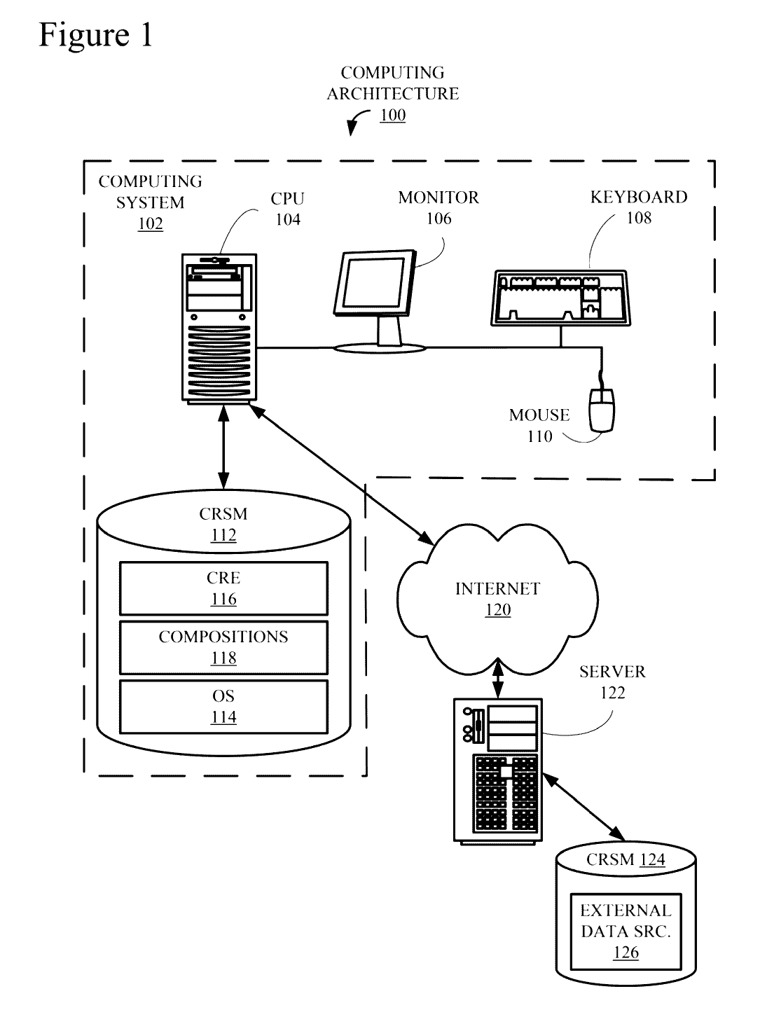

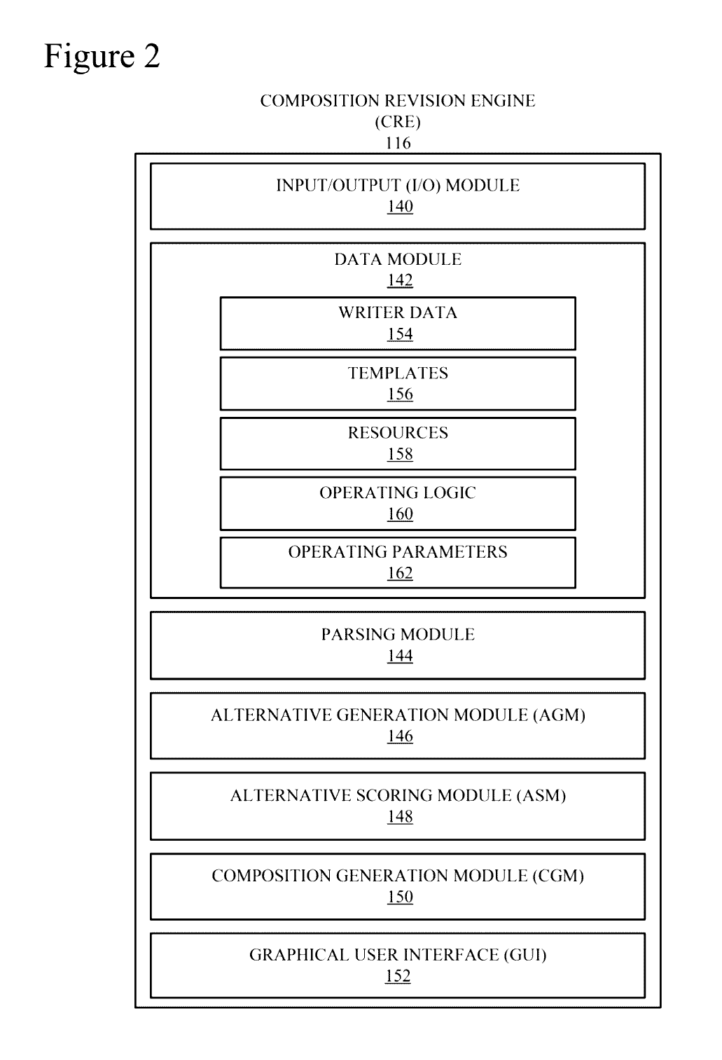

Turning now to the figures, FIG. 1 is a block diagram of one example computing architecture 100 that incorporates the claimed subject matter. A computing system 102 includes a central processing unit (CPI) 104, coupled to a monitor 106, a keyboard 108 and a pointing device, or “mouse,” 110, which together facilitate human interaction with computing system 100 and computing system 102. Also included in computing system 102 and attached to CPU 104 is a computer-readable storage medium (CRSM) 112, which may either be incorporated into computing system 102 i.e. an internal device, or attached externally to CPU 104 by means of various, commonly available connection devices such as but not limited to, a universal serial bus (USB) port (not shown). CRSM 112 is illustrated storing an operating system (OS) 114 and a Creative Revision Engine (CRE) 116. CRSM 112 also stores compositions 118, which is a collection of textual compositions, both unrevised and revised in accordance with the claimed subject matter. It should be noted that a typical computing system would include more than an OS and two other components, but for the sake of simplicity only the three components are shown. CRE 114 and compositions 116 are described in more detail below in conjunction with FIGS. 2-12.

Computing system 102 and CPU 104 are connected to the Internet 120, which is also connected to a server computer, or simply “server,” 122. Although in this example, computing system 102 and server 122 are communicatively coupled via the Internet 120, they could also be coupled through any number of communication mediums such as, but not limited to, a local area network (LAN) (not shown). Server 122 is coupled to a CRSM 124, which in this example stores an external data source (src.) 126. Examples of external data sources include, but are not limited to, dictionaries, synonym dictionaries, phonetic dictionaries, stern dictionaries and linguistic inquiry and word count (LIWC) dictionaries. Other resource may enable the identification of particular aspects of words and phrases. Such aspects may include, but are not limited to, sameness, part of speech, phonetic similarity, semantic similarity, mood, repetition, rhyme, simplicity, complexity, demography, age group, importance; and familiarity. Other aspects may include sounds of words, rhythm, orthographic properties; and mood and sense-based influences The possible makeup and use of external data source 126 is described in more detail below in conjunction with FIGS. 2-12. Further, it should be noted there are many possible computing system configurations, of which computing architecture 100 is only one simple example.

FIG. 2 is a block diagram of an example of CRE 116, first introduced in FIG. 1, that may implement the claimed subject matter. In this example, logic associated with CRE 116 is stored on CRSM 112 (FIG. 1) and executed on one or more processors (not shown) of CPU 104 (FIG. 1) and computing system 102 (FIG. 1). CRE 116 includes an Input/Output (I/O) module 140, a data module 142, a parsing module 144, an alternative generation module (AGM) 146, an alternative scoring module (ASM) 148, a composition generation module (CGM) 150 and a graphical user interface (GUI) 152. It should be understood that the claimed subject matter can be implemented in many types of architectures, computing systems and data storage structures but, for the sake of simplicity, is described only in terms of computing system 102 and system architecture 100 (FIG. 1). Further, the representation of CRE 116 in FIG. 2 is a logical model. In other words, logic associated with components 140, 142, 144, 146, 148, 150 and 152 may be stored in the same or separates tiles and loaded and/or executed within system 100 either as a single system or as separate processes interacting via any available inter process communication (IPC) techniques. In additions, components 140, 142, 144, 146, 148, 150 and 152 may be implemented as software, hardware or a combination of both.

I/O module 140 handles any communication CRE 116 has with other components of computing system 102 and architecture 100. Data module 142 is a data repository for information and instructions that CRE 116 requires during normal operation. Examples of the types of information stored in data module 142 include writer data 154, templates 156, resources 158, operating logic 160 and operating parameters 162.

Writer data 154 stores information relating to the characteristics of both users of CRE, 116 and writers that the users may want to emulate or from whom the user may like to differ, It should be understood that nearly any parameter that controls CRE 116 may be inversed. For example, a user may express a desire to generate short or not short (long) phrasing, difficult or simple words and to emulate or avoid a particular style. Briefly, templates enable users to identify word/phrases with a corresponding weighting by word/phrase for selected aspects. Such aspects may include, but are not limited to sameness, part of speech, phonetic similarity, semantic similarity, mood, repetition, rhyme, simplicity, complexity, demography, age group, importance; and familiarity. Other aspects may include sounds of words, rhythm, orthographic properties; and mood and sense-based influences.

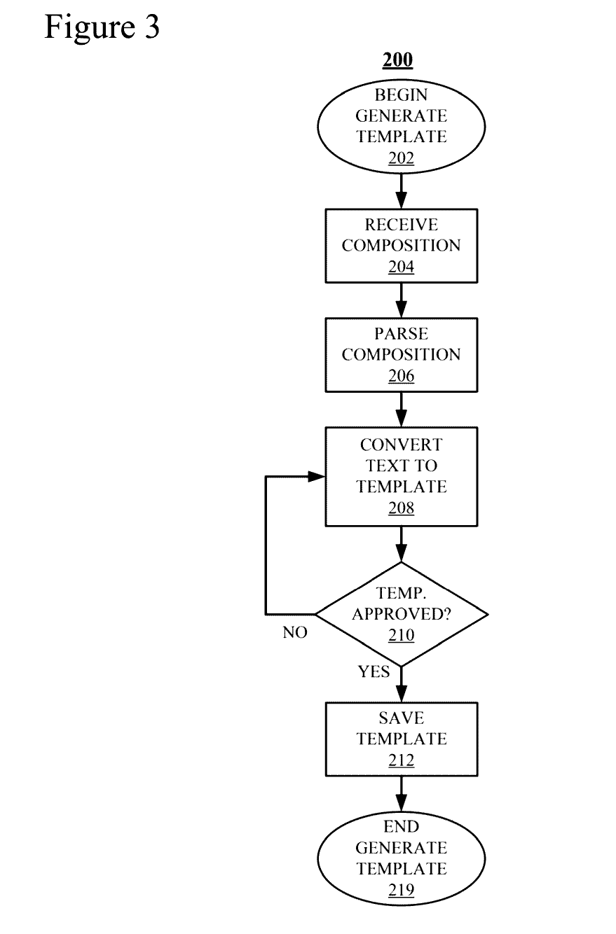

Templates 156 stores both sample templates and templates associated with particular compositions (see 208, FIG. 3). An example of a few lines of a composition and the resultant template associated with the composition are as follows:
Original Text:
   The woods are lovely, dark and deep,
   But I have promises to keep
   And miles to go before I sleep
Original Text converted to a Template:
   The (ref woods) are (lovely adj). (dark adj) and (deep adj),
   But I have (promise noun pl) to (keep verb :rhyme sleep)
   And (ref mile) to go before I (ref sleep)

It should be noted that the template above is simply one example. An example of the original text converted to a different template is as follows:
The (ref woods) are (<choose> adj :+sense [lovely pretty appealing]), <no line break>
(<choose> adj :+-sense [dark devoid black dismal dejected unilluminated]). <no line break>
and (<choose> adj :+sense [deep depth penetration extreme intense strong]), <line break>
But I have (promise noun pl) to (keep verb :rhyme sleep),
And (ref mile) to go before I (ref sleep),
And (ref mile) to go before I (sleep verb :different sleep :rhyme sleep).

In this example, relevant words are identified, characterized and labeled with respect to their syntax, whether they are plural and/or rhyme with other words. It should be noted that there are many features that may characterize words in accordance with the disclosed technology and the example above is not intended to be limiting in this respect.

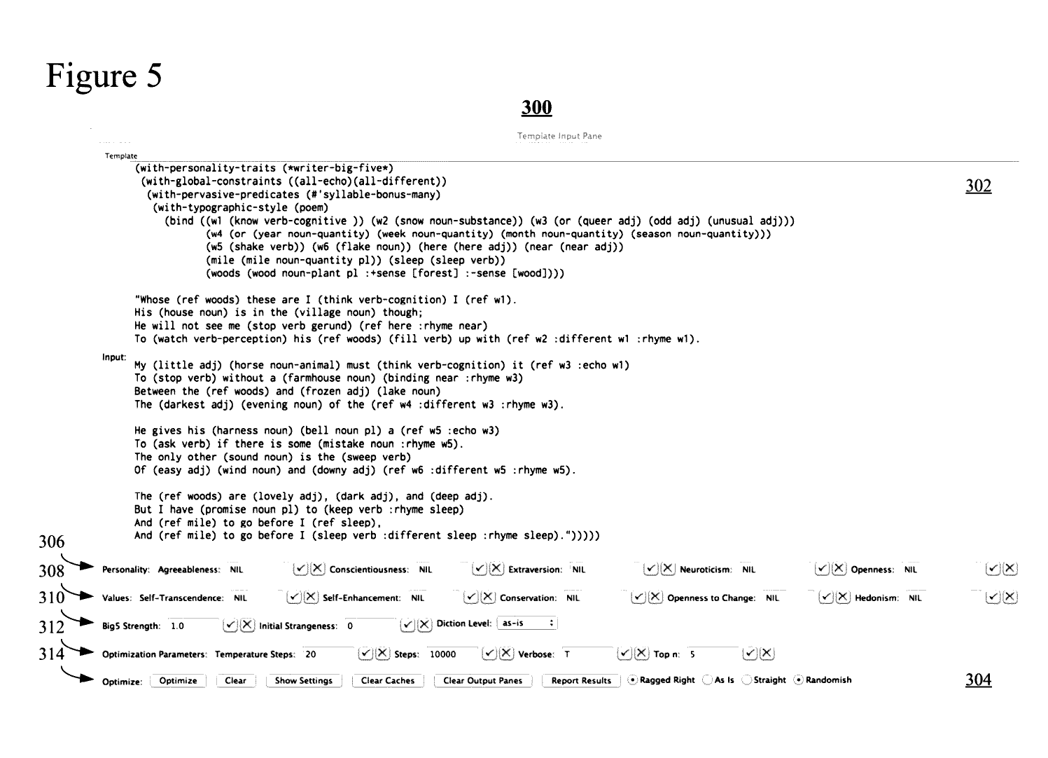

Sample templates may be based upon, but are not limited to, compositions of known writers and potential audiences. In addition, templates may be user defined (see FIGS. 5-12) or automatically generated based upon a sample composition. Sample templates may be utilized, to mimic or avoid as particular writer's style and exhibited characteristics or to revise a composition to target a particular audience. For example, a particular author may be mimicked or a particular audience targeted by the use of short words and short sentences. In other words, templates may be generated with respect to particular attributes and compositions modified to conform to those attributes. FIGS. 5-12 illustrate some examples of possible template definition tools provided by GUI 152.

Resources 158 stores information to enable CRE 116 to access various resources, both internal or external. For example, original, working and sample compositions may be stored in compositions 118 (FIG. 1) and external resources may be stored in external data source 126 (FIG. 1).

Operating logic 160 stores executable code to execute CRE 116. Operating parameters 162 stores information on user and administrative preferences that have been set for controlling the operation of CRE 116. Parsing module 144 is responsible for the organization of words of a composition to be processed into individual words so that the composition may be converted to a template. The conversion of text to template may be manual, semi-automated, i.e., the system will assist a human user make the template from the text, or totally automated.

Parsing module 144 is responsible for the organization of words of a composition to be processed into individual words so that the composition may be converted to a template. The conversion of text to template may be manual, semi-automated, or completely automated.

AGM 146 is responsible for generating alternative words in a composition in accordance with one or more templates and any instructions provided with respect to the degree of change requested. ASM 148 is responsible for taking the alternative words that have been generated by AGM 146 so that different alternatives may be evaluated, or “scored,” with respect to the desired changes. It should be noted that scoring algorithms may be manipulated to achieve desired results and that multiple templates may be evaluated, scored and normalized so that revised compositions corresponding to the multiple templates may be compared. A subset of scored compositions may then be presented to a user so that the user may select one for transmission to a target audience. Filters may be used to select a subset. Combining a filter with an *every-most* cutoff can result in interesting choices. If *every-most* is 100, and a filter returns a. number, then the system selects the one hundred (100) words with the highest values the filter returns. The system combines filters (and predicates), and if one of the filters specified in an <every> returns a number, the others wilt be turned into functions that return 1.0 for true and 0.0 for false. An example of a simple filter function that can be used to find words that rhyme with “dog” is as follows: (defun rhymes-with-dog (key & optional value) (rhyme? (first key) “dog”)) in which “Rhyme?” is a built-in function that returns a floating point number between 0.0 and 1.0 indicating “how much” its arguments—two words—rhyme. If you set *every-most* to 10 and stated: (<every> noun :filter #'rhymes-with-dog) here is one potential result:

| | |
|---|---|
| seeing-eye dog | 0.9960479 |
| crab-eating dog | 0.9960479 |
| devil dog | 0.9960479 |
| guard dog | 0.9960479 |
| top dog | 0.9960479 |
| domestic dog | 0.9960479 |
| pug-dog | 0.9960479 |
| badger dog | 0.9960479 |
| chrysanthemum dog | 0.9960479 |
| hyena dog | 0.9960479 |

The numbers (which in this example are the same) are how much each word rhymes with “dog. It should be understood that filters and scoring also apply to attributes other than “rhyme.”

CGM 150 is responsible fir generating a revises composition based upon the original composition, the generated alternative words and the scoring algorithms. Components 140, 142, 144, 146, 148 and 150 are described in more detail below in conjunction with FIGS. 3-12.

GUI 152 enables users of CRE 116 to interact with and to define the desired functionality of CRE 116 and enables users to more fully utilize the functionality of CRE 116, typically by providing the ability to access and manipulate templates stored in templates 156 and variables stored in operating parameters 162. Selected aspects of GUI 148 are described in more detail below in conjunction with FIGS. 5-12.

FIG. 3 is a flowchart of a Generate Template process 200 that may implement aspects of the claimed subject matter. In this example, process 200 is associated with instructions stored on CRSM 112 (FIG. 1) and executed on one or more processors (not shown) of CPU 104 (FIG. 1) in conjunction with CRE 116 (FIGS. 1 and 2).

Process 200 starts in a “Begin Generate Template” block 202 and proceeds immediately to a “Receive Composition” block 204. During processing associated with block 204, a composition is retrieved for processing. in this example, the received composition is stored and retrieved from compositions 118 (FIG. 1) although any storage and input technique may be employed. For example, computing system 102 may be configured as a CRE server such that a user on a different computer (not shown) may submit a composition over Internet 120 for processing. During processing associated with a “Parse Composition” block 206, the composition received during processing associated with block 204 is organized into word, lines and perhaps phrases. During processing associated with a “Convert Composition to Template” block 208, to template of the composition is generated. A simple example of a composition and the generated template are provided above in conjunction with FIG. 2. As explained above, conversion of text to template may be manual, semi-automated or fully automated.

During processing associated with a “Template (Temp.) Approved?” block, a determination is made as to whether or not the template generated during processing associated with block 208 meets the users requirements. In other words, a user may review a template and potentially revise the template by returning to block 208 or proceeding to a “Save Template” block 212 if the template is acceptable. Once a template has been saved, control proceeds to an “End Generate Template” block 219 in which process 200 is complete.

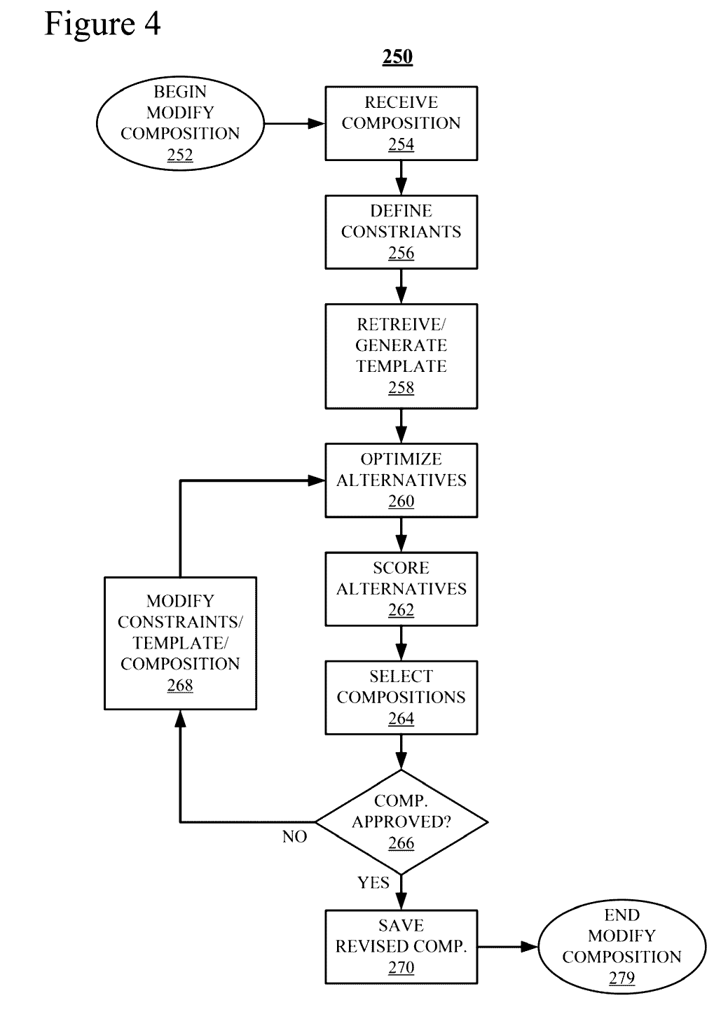

FIG. 4 is a flowchart of a Modify Composition 250 that may implement aspects of the claimed subject matter. Like process 200, in this example, process 250 is associated with instructions stored on CRSM 112 (FIG. 1) and executed on one or more processors not shown) of CPU 104 (FIG. 1) in conjunction with CRE 116 (FIGS. 1 and 2).

Process 250 starts in a “Begin Modify Composition” block 252 and proceeds immediately to a “Receive Composition” block 245. During processing associated with block 254, a composition to be processed in accordance with the claimed subject matter is retrieved. As explained above in conjunction with FIG. 2, a composition may be retrieved from compositions 118 (FIG. 3), submitted by a user on computing system 102 (FIG. 1) or on a remote device (not shown) or submitted by any other means that may be known to those with skill in the relevant arts. During processing associated with a “Define Constraints” block 256, a user may specify the various constraints to be applied to the modification. Examples of some different constraints may be seen in conjunction with FIGS. 5-12. During processing associated with a “Retrieve/Generate Template” block 258, a template corresponding to the composition received during. processing associated with block 254 is either retrieved from templates 156, if one exists, or generated (see 200, FIG. 3).

During processing associated with a “Optimize Alternatives” block 260, CRE 116 modifies the composition based upon the template retrieved or generated during processing associated with block 258 based upon the constraints defined for the process during processing associated with block 256. It should be understood that multiple alternatives are generated based upon a single composition, template and set of constraints. For example in a very simple example, “I love dogs” may generate “I love German Shepherds,” “I love wolves,” “I like huskies,” and so on. The optimization, or “simulated annealing,” process typically generates many alternatives. For example, if there are twenty (20) (temperature) Steps (see 312, FIG. 5) and one hundred thousand (100,000) Steps per Temperature (see 312, FIG. 5), the system examines 20*100000 or 2 million alternative revisions.

During processing associated with a “Score Alternatives” block 262, the alternatives generated during processing associated with block 260 are evaluated, or scored, and ranked based upon the scores. During processing associated with a “Select Compositions” block 264, a reasonable subset of the modified alternatives, based upon the rankings, is provided to the user for selection.

During processing associated with a “Composition (Comp.) Approved?” block 266, the user who initiated process 250 is given the opportunity to review the revised compositions. At this point, the user may decide that more processing is needed, i.e., the composition is not approved, and control proceeds to a “Modify Constraints/Template/Composition” block 268. During processing associated with block 268, the user may revise any or all of the constraints, template or original or modified compositions. The user may select, which compositions among the alternatives to submit for further processing. Once the appropriate aspects have been revised, control returns to “Optimize Alternatives” block 260 and processing continues as described above in accordance with the revised constraints, templates and/or compositions.

If a user is satisfied with one or more modified composition, i.e., modified compositions are approved during processing associated with block 266, control proceeds to a “Save Revised Comp.” block 270 and the modified compositions are either saved to compositions 118 or transmitted to a particular targeted audience or users. It should be noted that process 250 in general and blocks 260, 262 264, 266 and 268 in particular represent an iterative process in which as user is able to generate a revised document, make changes to the process, generate additional revisions and continue until satisfied with the process. Finally, control proceeds to an “End Modify Composition” block 279 in which process 250 is complete.

FIG. 5 is an illustration of a Template Input Pane 300 that may implement aspects of the claimed subject matter, Template Input Pane 300 is where a user inputs the initial template, also referred to as the “annotated text.” An example of annotated text is visible in a text input screen 302, starting in the first line with “(with-personality-trans (*writer-big-five*)” and so on. If the template doesn't have any prepended modifiers (like (with-personality-traits . . . ), (with-global-constraints . . . ), (with-pervasive-predicates . . . ), (with-pervasive-filters . . . ), (with-typographic-style . . . ), or (bind . . . )), the text does not need to be quoted (inside “quotes”).

A trait definition area 304 enables a user to check off various traits. In this example, a Personality row 306 corresponds to personality traits and includes “Agreeableness,” “Conscientiousness,” “Extraversion,” “Neuroticism” and “Openness.” Row 306 set the targets fir these Big 5 personality traits. Entries may be numbers in the range [−100,100], a pair of numbers ([−100,100], [−∞,∞]), or NIL. NIL means that the trait is ignored. (x,y) means to aim for x as a target, and the bonus for that is y. Unless specific target values for a writer are known, in practice, the most useful settings are NIL, a moderately large (absolute value) positive, or a moderately large negative number (both with absolute value no more than 100). This is because target numbers are typically not hit exactly. That is, the most useful inputs may be be simply NIL (ignore), Positive, and Negative.

A Values row 308 includes “Self-Transcendence,” “Self-Enhancement,” “Conservation,” “Openness to Change” and “Hedonism.” These values are treated like the Big 5 and are facets of the Big 5 personality model. A Strength row 310 includes “Big5 Strength,” “initial Strangeness” and “Diction Level.” The overall approach is to assign strengths to the various template constraints. Ranges for Big5 Strength are typically technically [0,∞], but an effective/useful range for strengths of this nature are approximately [0,50]. In this example, a positive strength tells the system to attempt to achieve the targets, and a negative strength to avoid achieving the targets. With respect to Initial Strangeness, a user typically operates by allowing CRE 116 to compile a set of alternative word choices for each annotated word. If Initial Strangeness is 0, optimization (see 146, 148, FIG. 2) begins with the words specified in template 302 and looks at alternatives to them for improvement. This value tells the system what percentage of those initial words should be replaced with words randomly selected from the sets of their alternatives; and at that point, optimization tries to improve on those selections. The range is [0,100]. a non-zero Initial Strangeness may improve the thoroughness of optimization. If optimization is running in multiprocessing mode (the default), the various threads use a spread of values for this. Diction Level may be as-is, Formal, or informal. As-is leaves the wording as specified in the template; Formal expands contractions and informal introduces them. Optimization uses a variant of simulated annealing designed for this type of task, operating by randomly replacing words and checking constraints to compute a goodness value. Typically the algorithm will accept a proposed change only if the score improves by making the change; but the space can be better explored by sometimes making changes that make things worse. A value called a “temperature,” explained below controls that.

An Optimization Parameters row 312 controls the temperature algorithm. Row 312 includes “Temperature Steps.” which sets the number of discrete values for the temperature value. Each of these steps decreases the temperature. The higher the temperature, the more likely the algorithm will make a de-optimization step. [0,∞]. A “Steps” value controls how many algorithm steps (word and phrasing selections) to make at each temperature step. The more temperature Steps (T) and the more Steps (S) per temperature are specified, the more thoroughly the algorithm will explore the space of word and phrasing choices. T*S is the total number of steps performed. With n processes, each process looks at T*S/n steps. The range of Temperature Steps and Steps is [0,∞]. A “Verbose” value controls whether to list statistics of the optimization process on the console. [T,NIL]. A “Top n” value controls how many of the best revisions to keep and then display with a range or [0,∞].

An Optimize row 314 is a set of action buttons and a pair of formatting radio buttons, An “Optimize” button initiates the revision process. A “Clear” button clears the input pane. A “Show Settings” button shows the settings for pane 300. A set of caches (not shown) is used to store intermediate information during the revision process to speed up computational aspects. A “Clear Caches” button is used to clear these caches, including caches for rhymes and echoes, which can grow very large and are explained in more detail below. Settings that change how fir and wide the search for alternatives ranges may clear this cache automatically, as might the presence of <choose> and <every> in the template. Clearing these caches frees storage to be used in later computations as well as eliminating any possibility of information clashes. A new output pane is created each time a revision is made to display the top n revisions and the settings used to create them. A “Clear Output Panes” button clears the output panes from the system. A “Report Results” button re-displays the current Top n revisions in a new output pane. A “Ragged Right” radio button causes revisions to be printed ragged right, which is a good way to display prose. An “As is” radio buttons enable revisions to obey the line breaks from the template reviser input pane, which is good for displaying poetry. A “Randomish” radio button controls whether each process gets a diversity of values of the Temperature Steps and Steps parameters so that the search space may be searched more randomly. A “straight” radio button control whether each process gets the same values for these parameters.

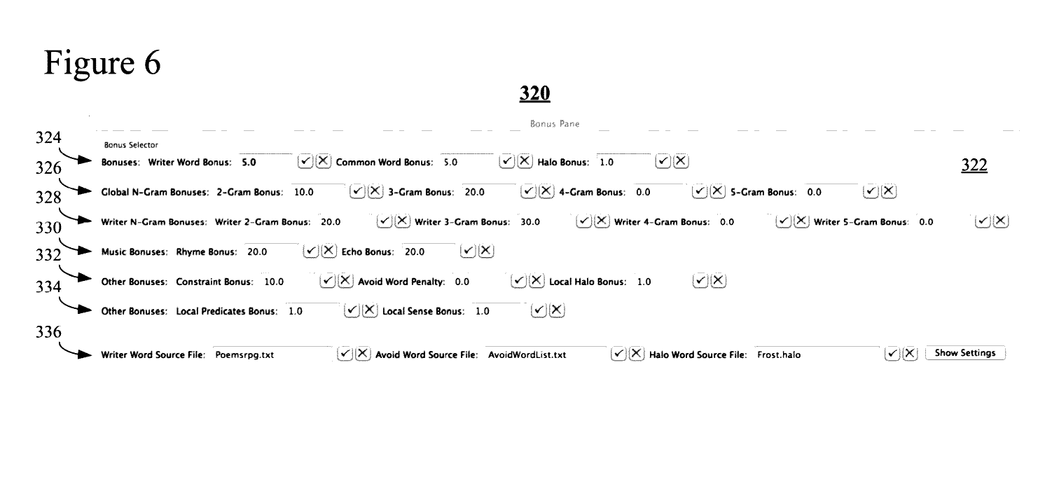

FIG. 6 is an illustration of a Bonus Pane 320 that includes a number of entry boxes 322 for setting various parameters. Pane 320 contains the bulk of the constraint bonus settings. In this example, when a value can take on either positive and negative values, a positive value directs the system to try to satisfy the constraint to the degree specified, and a negative value directs it to try to avoid the constraint (that is, break it) to the degree specified.

Whenever a bonus is specified fir example, for a Rhyme or Writer 4-Gram—it is used in the optimization process to determine the relative importance of the specified revision characteristics. Each such bonus is associated with a function or predicate that is used to measure characteristics of a text. For example, the predicate “Rhyme?” takes two words and returns a number between 0.0 and 1.0 that indicates bow much those words rhyme (0.0, not at all; 1.0 total rhyme). The bonus is used as a weight in the optimization process to set how much that predicate matters to the revision, where a positive number indicates the revision should favor words and phrases that increase the value of that predicate, a negative number indicates the revision should favor words and phrases that reduce or even make negative the value of that predicate, and 0.0 means to ignore the predicate (and in fact, a value of 0.0 will cause the predicate to not be invoked).

To continue the example, if the bonus for rhyme is positive, the revision process will try to make the indicated words rhyme, and the larger that bonus, the more important that rhyme is to the revision. If the bonus is negative, the revision process will try to make the indicated words not rhyme, and the larger the magnitude of that bonus, the more important the non-rhyme is to the revision. If 0.0, the revision process will ignore whether the words rhyme (and will not even compute how much they rhyme). This treatment of bonuses holds for all aspects of the process that takes a bonus.

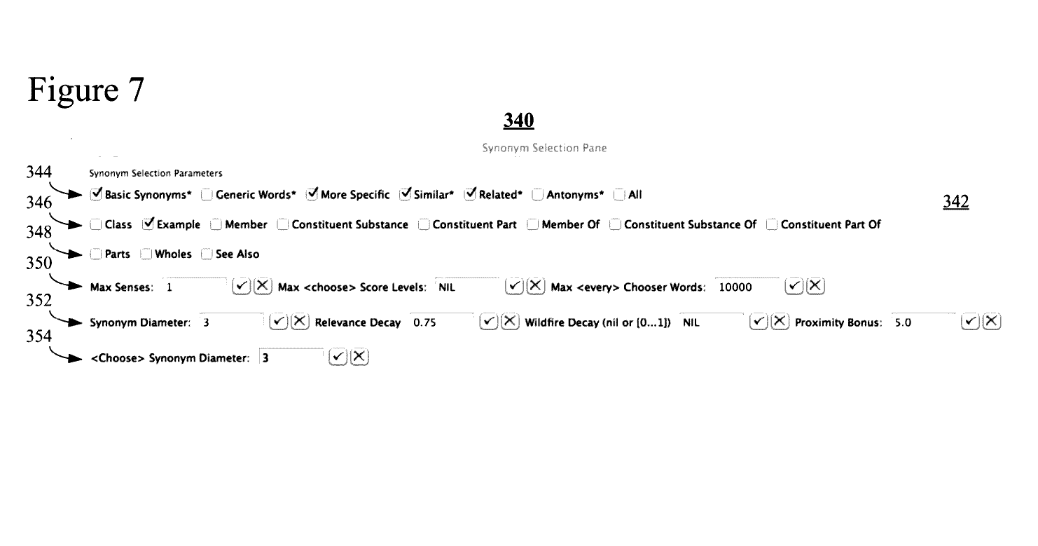

A “Bonuses” row 324 includes a “Writer Word Bonus,” which is a bonus for using words drawn from a Writer's corpus and has been loaded as specified by the Writer Word Source File or the Writer/Halo Presets Pane. A positive number directs the system to prefer words drawn from the writer's corpus; a negative one directs the system to prefer words not drawn from that corpus. In this manner a user can direct a revision that sounds like a particular writer versus one that sounds like anyone but that writer. A “Common Word Bonus” is a bonus for using words drawn from the set of 20,000 or so most common English words. A “Halo Bonus” is a bonus for using words in the halo specified by the Halo Word Source File. A halo is a structure that influences the choice of words and phrasings An example of an algorithm to generate a halo is as follows: “Take a set of words. For each word, visit synonyms up to the spreading depth specified by Synonym Diameter. The strength associated with a word is the number of such spreadings that touch that word. For example, if a halo is specified by two words, and a particular word is visited three times while activation spreads from those two words, its halo strength is 3. This imparts a mood based on the halo words. For example, given a halo reflecting “happy” words, “The woods are lovely, dark and deep” revises to “The woods are bright, light and high.” Changing only the governing halo to one reflecting “angry” words produces, “The woods are hot, rough and cold.” A “Proximity” bonus (see row 353, FIG. 7) specifies that when searching for word alternatives, the system begins at each word and visits synonyms (and generic terms, related words, similar words, and antonyms) one hop at a time. The strength of a word is proportional to the number of steps away it is from the seed word that started the spreading. This bonus tells the system how important it is to be near the seed. A default can work for this.

Bonuses associated with a “Global N-Gram Bonuses” row 326 are derived from a number of general corpora and those associated with a “Writer N-Gram Bonuses” row 328 are derived from the writer whose corpus, which are loaded into the system for use by the Writer Word Bonus. Global N-grain Bonuses 326 include bonuses for 2-, 3-, 4-, and 5-grams for the general n-grams. For example, there is as bonus for each pair of words that appears in the global 2-gram set, one for each triple of words (in sequence) from the 3-gram set, etc. Each of these bonuses is associated with a text box. Typical values for the 2-5grams may be: x, 2x, 4x, 8x, for values in the range [−∞,∞], such values indicating that appearing in a 5-gram is 8 times more important than a sequence of two words appearing in a 2-gram. Writer N-Gram Bonuses 328 are like Global N-Gram Bonuses 326 but the n-grams are derived from the file specified in the Writer Word Source File box or by the Writer/Halo Preset Pane and are scored in the range [−∞,∞].

A Music Bonuses row 330 has to do with the sound of words. Music Bonuses 330 include a “Rhyme Bonus,” which draws from, in this example, two sources of rhyming information. A first source is a simple rhyming dictionary and the second is algorithmic rhyming based on a CMU Phonetic Dictionary (see 126, FIG. 1). The phonetic dictionary tells for each word in it how it's pronounced (including stresses) using, a simple ascii encoding. Algorithmic rhyming is computed by comparing the sounds described in the phonetic dictionary for the syllables of the two words or phrases being considered. starting at the ends of those two words or phrases, and further considering syllables moving toward the starts of those words and phrases, decaying relevance as the scan proceeds. in other words, Rhyme Bonus is a bonus for specified words that should rhyme—either specified in the template pair by pair, or in a global rhyming setting that says that all the words should rhyme (this includes the fixed words) and scored. An Echo Bonus is like the Rhyme Bonus but for a more loosely defined musical term called “echo.” One word echoes another if it shares sounds with it. So alliteration and assonance. “L” sounds, “D” sounds, etc. This is performed algorithmically and scored numerically.

In this example, there are also two “Other Bonuses” rows 332 and 334. A “Constraint Bonus” affects constraints that can be specified between words, most of which are subject to specific other bonuses e.g., Rhyme and Echo. Constraint Bonus applies to relationships defined between pairs, triples, and etc, of words or phrases; these include but are not limited to All-Different (which says all the selected words should be different), All-Echo, All-Rhyme, and Bare-Syllabics (which tries to constrain syllable count fur an entire revised text and may be used in a haiku writing application).

An “Avoid Word Penalty” bonus is a type of inverted bonus, i.e., a positive value means that words specified in the Avoid Word Source File should be avoided to this degree (so, it's like a negative bonus is attached to the words) and a negative value means the words in the Avoid Word Source File should be preferred to this degree (so, like a positive bonus). In other words, a large positive number tells the system to try really hard to actually avoid the words in the Avoid Word Source File.

A “Local Halo Bonus” specifies the bonus for words that have local halos attached to them. This is the bonus for selecting words influenced by a particular halo. A “Local Predicates Bonus” specifies the bonus for words that have predicates attached to them. For example, syllable-bonus-few, which returns a number that is directly related to the number of syllables in the word favors words with fewer syllables. This is the bonus for those predicates.

A “Local Sense Bonus” exemplifies that the primary notion of semantics in the system is captured in distance in the network of synonyms in the system. The word, “woods,” for example is related to the word “wood,” but a sense can be used to bias the choice of words chosen to replace “woods” to be more like “forest” (for example) than like the material used to make tables and other furniture. One may also specify that synonyms for “dog” should be more like “canine” than like “frankfurter” or “hot dog.” This is called a sense. These senses can be specified as described below. Local Sense Bonus is the bonus for obeying them.

The last row 336 in pane 320 is for specifying, a set of corpus files, and an action button, A “Writer Word Source File” specifies the file containing text for a particular writer. The specified named file is used to bias word choices and for writer-specific n-grams. An “Avoid Word Source File” specifies a file containing words to avoid. A “Halo Word Source File” specifies a file containing the global halo words. A “Show Settings” button shows the settings in force that can be set in pane 320.

FIG. 7 is an illustration of a Synonym Selection Pane 340, including a number of check and entry boxes 342, that may implement aspects of the claimed subject matter. Pane 340 is the first of two panes for determining how synonyms are selected for alternative word choices. The top three rows 344, 346 and 348 control what sorts of synonyms to look far and the last row 354 determines how far and wide the search goes in the synonym network. Each synonym dictionary entry. i.e., each word known to the system whether internally or externally (see 126, FIG. 1) has a set of associated “synonym sets,” each containing the basics about that sense of the word—in almost all cases including glosses or short definitions—as well as a set of different types of synonyms. The synonym network is really a network of these words and their senses. For example, the various senses of the noun “dog” include:

1. domestic dog. NOUN-ANIMAL: a member of the genus Canis (probably descended from the common wolf) that has been domesticated by man since prehistoric times; occurs in many breeds; “the dog barked all night”

2. dog, NOUN-PERSON: a dull unattractive unpleasant girl or woman; “she got a reputation as a frump”; “she's a real dog”

3. dog, NOUN-PERSON: informal term for a man; “you lucky dog”

4. cad, NOUN-PERSON: someone who is morally reprehensible; “you dirty dog”

5. wiener, NOUN-FOOD: a smooth-textured sausage of minced beef or pork usually smoked; often served on a bread roll

6. detent, NOUN-ARTIFACT: a hinged catch that fits into a notch of a ratchet to move a wheel forward or prevent it from moving backward

7. dog. NOUN-ARTIFACT: metal supports for logs in a fireplace; “the andirons were too hot to touch”

The particular types of synonyms to look at are selected by the following checkboxes—checkboxes with asterisks next to them are common selections. It should be noted that there are different, equally relevant ways to direct how synonyms are selected. A “Basic Synonyms” specifies words that are the basic synonyms for a particular word sense. A “Generic Words” specifies the words that describe the current sense, but one level of generalization up; sort of like a superclass. If the sense is dog-as-animal, this would include “canine” and “domesticated dog.” In the literature, these are called hypernyms. A “More Specific” is the opposite direction to Generic Words; sort of like a subclass. If the sense is dog-as-animal, this would include “puppy” and “pooch.” In the literature these are called hyponyms. A “Similar” specifies similar words. For example, if the word is “meek,” a similar word might be “docile.” An “Antonyms” specifies words that have an opposite meaning. A “Related” specifies related words. For example, if the word is “prudent,” a similar word might be “wise.” The difference between Related and Similar is subtle, and the system simply uses whatever the synonym dictionary provides.

A “Class” specifies a classification for a. particular word. For example, if the word is “Marilyn Monroe,” then the Class might be “actress.” In the literature these are called instance hypernyms. An “Example” specifies examples of a particular word. For example, if the word is “theologiser,” then the Example might be “St. Thomas Aquinas.” In the literature these are called instance hyponyms. A “Member” specifies that words are members of this set. For example, if the word is “pantheon” (all the gods), then the Member might be “god.” In the literature these are called member metonyms. A “Constituent Substance” specifies a substance that makes up this word. For example if the word is “soy milk,” then its Constituent Substance might be “soy flour.” In the literature these are called substance meronyms. A “Constituent Part” specifies a part that makes up this word. For example if the word is “billiards,” then its Constituent Part might be the “break.” In the literature these are called part meronyms.

A “Member Of” specifies words of which that this word is a Member. For example, if the word might be “Eastern Coral Snake,” then Member Of might be “genus micrurus.” In the literature these are called member holonyms. A “Constituent Substance Of” specifics the thing, of which this word might be a constituent substance. For example, if the word is “curd,” then the Constituent Substance Of might be “cheese.” In the literature these are called substance holonyms. A “Constituent Part Of” specifies the thing of which this word might be a part. For example, if the word is “plumbing fixture,” then the Constituent Part Of might be “plumbing system.” in the literature these are called part holonyms.

Row 348 includes “Parts,” “Wholes” and “See Also.” Parts is a union of Member. Constituent Substance and Constituent Part. Wholes is a union of Member Of, Constituent Substance Of and Constituent Part Of. See Also specifies variously related words. For example, if the word is “wash,” then See Also might be “wash up.” An “All” specifies a union of all synonym entries.

Row 350 includes a “Max Senses.” that specifies that if there are no other ways of specifying appropriate synonym senses of the word, how many of the senses to use, sorted from most frequently used sense to least. If Max Senses is NIL, it uses all Of the senses. A “Synonym Diameter” specifies how far the search for synonyms extends. Eight (8) is about the largest number most people would tolerate in terms of execution performance—both the selection of word alternatives and the required number of optimization steps to really explore well the word-choice space. Moreover, straying, too far will make for some interesting rewordings. A “Max <choose> Score Levels” refers to an annotation that chooses words instead of being told a word to start with. For example, the system may start with a suggested word and find suitable synonyms, and also it can start with a description of the desired word and can find words that satisfy that description. This field is for specifying how many words to find in that case. If to number, this is the number of score levels to accept not the top n words, but all the words in the top n score levels. If there are twenty words with the top score, specifying 1 in this field will get all twenty. NIL means take them all. That is, after <choose>, this is how many synonym hops away from those words the system will search. A “Max <every> Chooser Words” refers to an annotation that also chooses words, but selects them in a sort of wildcard fashion, This field says how many to use. NIL means take them all. A “Synonym Diameter” specifies how far a search ⁻for synonyms extends for words chosen by <choose>.

A “Relevance Decay” specifies how the relevance of words changes the farther from the seed word (the word whose alternatives are being sought) they are. This is the degree of decay for each step away from the seed word. So if the decay rate is 1/2, then at three steps away the relevance will be 1/8. This specifies that rate, but the value it can take on is any floating point number. A “Wildfire Decay” for trying to do very long spreading chains without taking forever. Essentially, for each seed word, the program gathers alternatives until a random number generator tells it to stop, and this Decay value tells the system how quickly to squelch further search steps. This is best explained mathematically. At each step away from the seed word, a random number generator chooses a floating point number in the range [0.1]. And at each step in the search, a threshold is decreased by this Decay rate factor. The threshold may start at 1 and the search continues if the random number is below this threshold. The search might be cut oft very quickly, or it could go quite deep. This value can be NIL, which means don't use Wildfire, or a floating point number [0,1]. A default can also work for this.

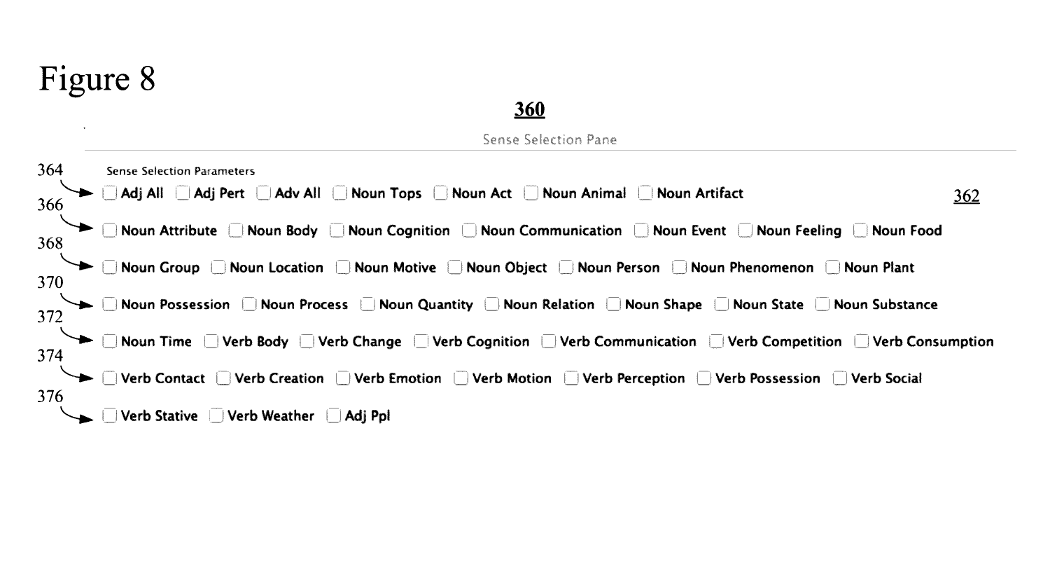

FIG. 8 is an illustration of a Sense Selection Pane 360 that may implement aspects of the claimed subject matter. Template form 362 is annotated with the parts of speech of the words that should be considered by the system. The synonym dictionary has its senses labeled. Panel 360 enables users to choose synonym senses globally. (Local part of speech annotations can use these specific terms, and is one method of specifying the semantic type of a word or phrase selection.) When the system is searching for synonyms, if a synonym sense is among those checked of in this panel, that sense will be used. For example, if the system is searching for a synonym for “dog” considered a noun, if the box Noun Food is checked, the system will use the sense of the word as in “sausage.” Here is a table with the meaning of the checkboxes of rows 364, 366, 368 270, 372, 372, 374 and 376:

| Marker | Meaning |
|---|---|
| adj.all | all adjective clusters |
| adj.pert | relational adjectives (pertainyms) |
| adv.all | all adverbs |
| noun.Tops | unique beginner for nouns |
| noun.act | nouns denoting acts or actions |
| noun.animal | nouns denoting animals |
| noun.artifact | nouns denoting man-made objects |
| noun.attribute | nouns denoting attributes of people and objects |
| noun.body | nouns denoting body parts |
| noun.cognition | nouns denoting cognitive processes and contents |
| noun.communication | nouns denoting communicative processes and |
| | contents |
| noun.event | nouns denoting natural events |
| noun.feeling | nouns denoting feelings and emotions |
| noun.food | nouns denoting foods and drinks |
| noun.group | nouns denoting groupings of people or objects |
| noun.location | nouns denoting spatial position |
| noun.motive | nouns denoting goals |
| noun.object | nouns denoting natural objects (not man-made) |
| noun.person | nouns denoting people |
| noun.phenomenon | nouns denoting natural phenomena |
| noun.plant | nouns denoting plants |
| noun.possession | nouns denoting possession and transfer of possession |
| noun.process | nouns denoting natural processes |
| noun.quantity | nouns denoting quantities and units of measure |
| noun.relation | nouns denoting relations between people or things |
| | or ideas |
| noun.shape | nouns denoting two and three dimensional shapes |
| noun.state | nouns denoting stable states of affairs |
| noun.substance | nouns denoting substances |
| noun.time | nouns denoting time and temporal relations |
| verb.body | verbs of grooming, dressing and bodily care |
| verb.change | verbs of size, temperature change, intensifying, etc. |
| verb.cognition | verbs of thinking, judging, analyzing, doubting |
| verb.communication | verbs of telling, asking, ordering, singing |
| verb.competition | verbs of fighting, athletic activities |
| verb.consumption | verbs of eating and drinking |
| verb.contact | verbs of touching, hitting, tying, digging |
| verb.creation | verbs of sewing, baking, painting, performing |
| verb.emotion | verbs of feeling |
| verb.motion | verbs of walking, flying, swimming |
| verb.perception | verbs of seeing, hearing, feeling |
| verb.possession | verbs of buying, selling, owning |
| verb.social | verbs of political and social activities and events |
| verb.stative | verbs of being, having, spatial relations |
| verb.weather | verbs of raining, snowing, thawing, thundering |
| adj.ppl | participial adjectives |

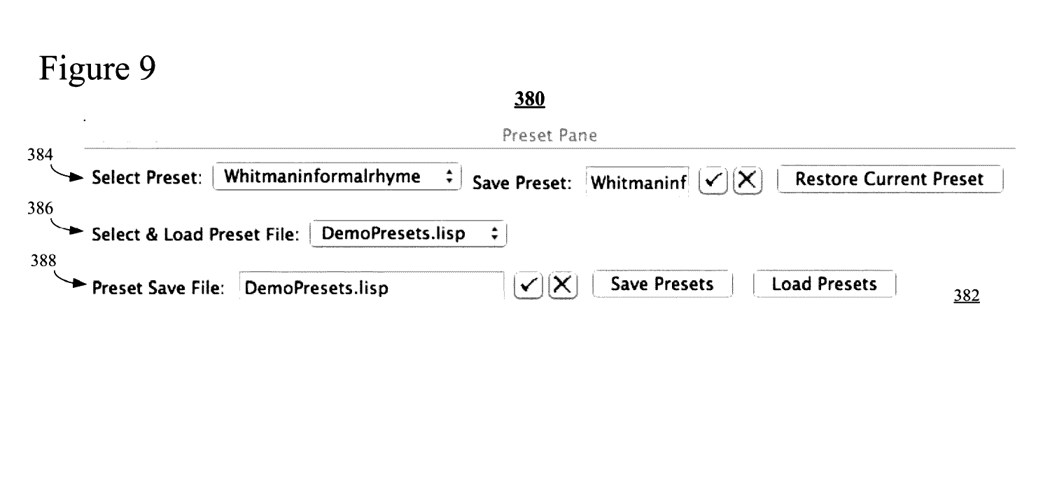

FIG. 9 is an illustration of a Preset Pane 380, including a number of pulldown lists and checkboxes 382, that may implement aspects of the claimed subject matter. Preset pane 380 is employed for managing preset settings groups. The panel is reasonably intuitive. A set of named presets are kept in memory. New ones can be defined and existing ones redefined. The in-memory presets group can be saved to disk and retrieved. When a preset is selected, all its specified settings are restored, and files it specifies are re-analyzed. The only setting not saved or restored is Initial Strangeness (see row 310, FIG. 5). Once settings are restored, they can be re-adjusted without affecting the preset's definition. If the preset is saved with the same name as an existing one, the values are rewritten or a new name may be chosen. The entire set of presets can be saved to disk at any time (see 156, FIG. 2). A special preset is named Initial (not shown), which is the set of defaults upon creation of the system (see 162, FIG. 2).

A first row 384 includes a “Select Present” a “Save Preset” and “Restore Current Preset” Select Preset is a pull-down list of existing presets; any of them can be selected. All files defined in the preset, such as but not limited to a Writer Word Source File, are re-read and re-analyzed. The name of the currently selected preset is shown in the closed pulldown and in the Save Preset box. Save Preset saves the current settings under the name shown when the green check box is clicked. The name of the current preset has an asterisk next to it when its defined settings have been changed but not saved to disk. Restore Current Preset restores the original presets if changes are made to settings The original settings for that preset can be restored by pushing this button.

The second row 386 includes a “Select & Load Preset File” pull-down list. Files in the Presets directory are listed in this pulldown menu. Selecting one also loads the corresponding file. The third row 388 includes a “Preset Save File,” a “Save Presets” and “Load Presets.” Preset Save File specifies the file where the preset group is stored. This can be changed to save the current group definitions somewhere else and to preserve existing settings. When you type in a name, there are two situations: the first is that the file does not already exist; in this case, the system puts that file in the Presets directory unless you specify the directory you want to use. If the file does exist, the system will find it as long as it is somewhere under the top level directory in which the system is installed. Save Presets saves the current group of presets in the specified file. Load Presets loads the group of presets from the specified file.

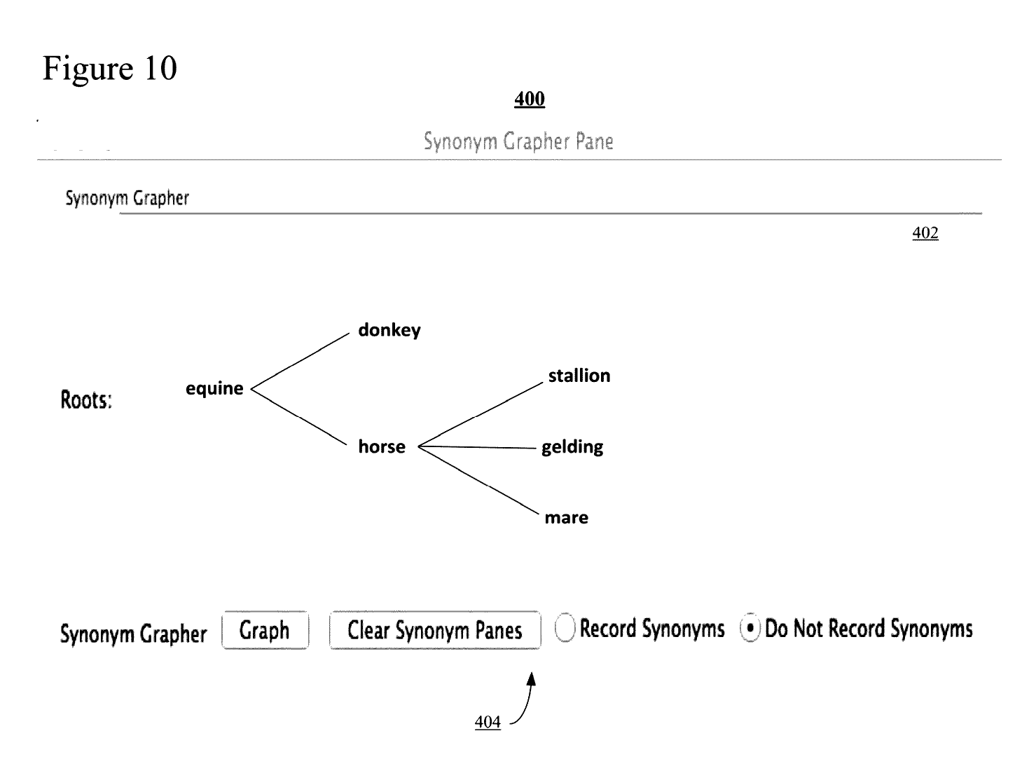

FIG. 10 is an illustration of a Synonym Grapher Pane 400 that may implement aspects of the claimed subject matter. Synonym Grapher Pane 400 is for examining the synonym choices the system has used for the most recent revision. In this example, some choices tier the word “equine” are displayed in a Roots window 402. To examine synonyms, the system must first record the synonym choices made. To record synonyms, a “Record Synonyms,” located in row 404 along the bottom of pane 400, is selected then Template Input Pane 300 (FIG. 5) is employed to do the revision. Once the revision is done, words the user wants to explore are displayed or the user may enter “All” to explore all the words at which the system looked. This will bring up as many grapher panes (not shown) as synonyms explored, each labeled with the word explored. You can clear all of them by pressing “Clear Synonym Panes” in row 404.

An asterisk indicates a word whose synonym descendants are also considered that is a nonterminal; a word in (parentheses) indicates an antonym. Words entered into the Roots: pane but not considered by the system are ignored. A user may enter a pair of words like this (equine horse). The format is (root word). If root is the root of a synonym tree explored by the system, and word is a synonym descended from that root, then this will display the part of the tree rooted at word. This helps explore a deep and dense tree. For example, if (horse stallion) is entered after the exploration at the right, the system displays just part of that branch. “Do Not Record Synonyms” in row 404 turns synonym recoding off.

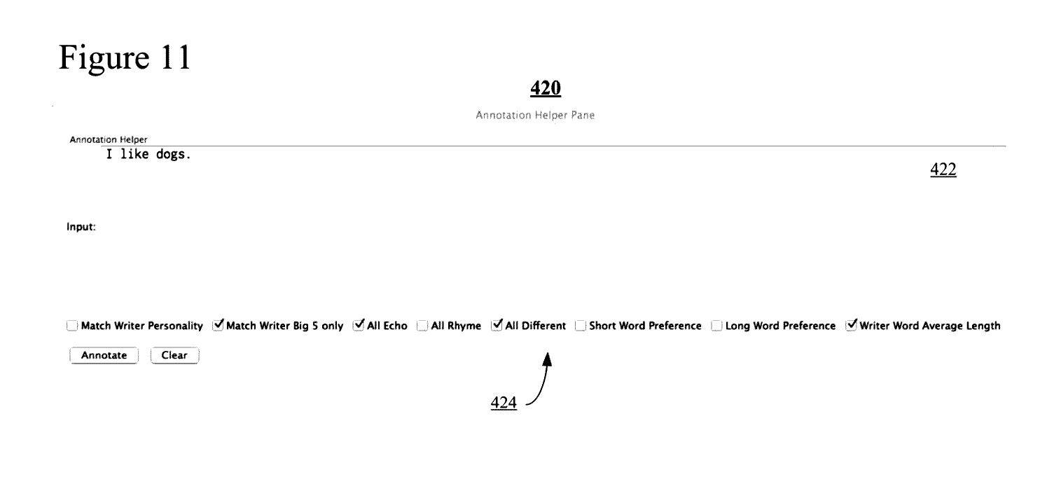

FIG. 11 is an illustration of an Annotation Helper Pane 420 that may implement aspects of the claimed subject matter. Creating effective templates can be time consuming and difficult. Pane 420 makes this a little easier. A user types in text they want to revise into a window 422, and select some of the global attributes they want the system to obey in a row 424 Then, the system guides the user through selecting what the user means by the words. There are four types of panes (not shown) the system uses as it moves loll to right through the text. One is used when the system has to use stemming to guess the word user meant. This happens, for example, when the use uses plurals and other forms of the word—such as dogs. In most cases, this isn't noticed and the system simply follows instructions, but sometimes it will seem non-intuitive. Usually for stemmed words the user sees several variations, like dogging, dog, and dogged. The user may simply select the intended word.

The second type of pane shows where you are in the annotation process. It's called the Annotation Viewer (not shown), and it shows the full text being annotated, and where the user has highlighted. If the user has added a label or made a word a global ref (a binding), the pane will display that as well with [words] in brackets meaning, they're globals and (words) in parenthesis meaning they are local labels.

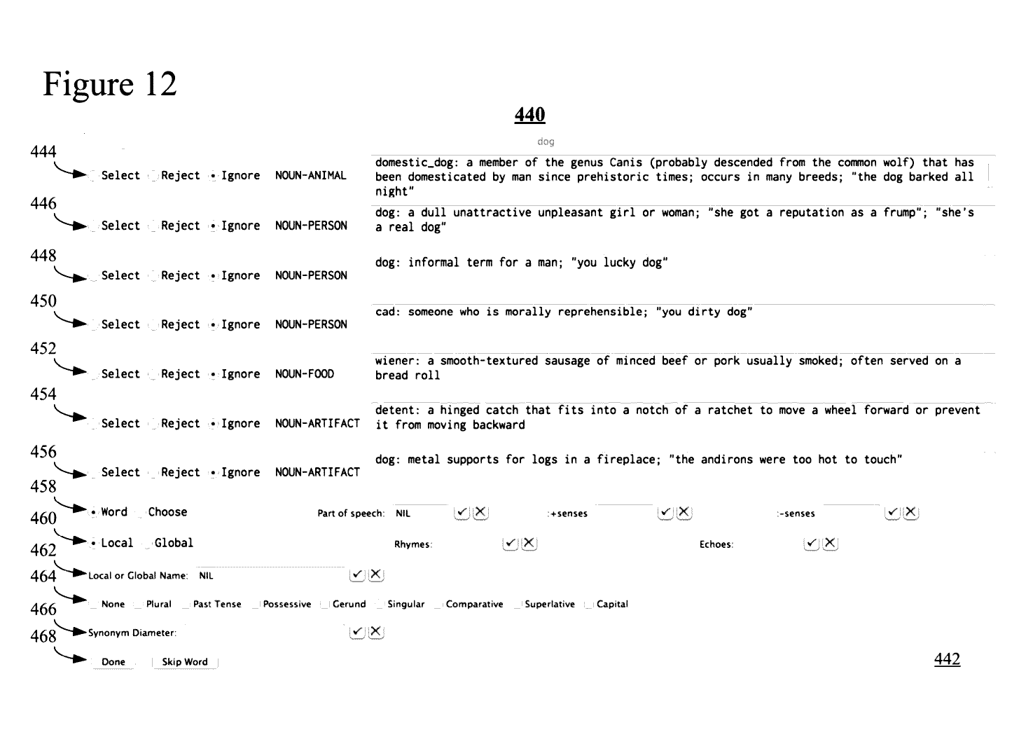

FIG. 12 is an illustration of another Annotation Helper Pane 440 that may implement aspects of the claimed subject matter. In short, pane 440 presents all the possible senses of the word in question, and user may, by selecting the appropriate radio buttons in rows 444, 446, 448, 450, 452, 454 and 456, “Select,” “Reject,” or “Ignore” any of them. Selecting a sense means the system tries to pursue synonyms with that sense; rejecting it means the system tries to avoid such senses; and ignoring it means the system will not consider it one way or the other. “Select” directs the system to look explicitly at the sense and to inject a “:+Sense” data structure into its search criteria. Reject will direct the system not to look at that sense and to inject a “:−Sense” data structure into its search criteria. Ignore will neither direct the system to consider the sense nor to avoid it, and neither a :+Sense nor :−Sense will be injected. In row 458, “Word” directs the system to start with words and phrases that are synonyms of the displayed word; “Choose” tells the system to select words and phrases based on any senses specified in rows 444, 446, 448, 450, 452, 454, and 456, along with any sense words added in the :+senses and :−senses boxes. A part of speech (e.g. NOUN) or semantic-type (e.g. NOUN-ANIMAL) can be specified or added by typing in the Part of Speech box when Choose is selected. In row 460, the use can indicate “Rhymes” and “Echoes,” either by referring to names or constant words the example shown, if you put hamburger in the rhyme input text box, the word being annotated would be told to try to rhyme with the word “hamburger.” If you labeled another word as hamburger, then the system would try to make this word rhyme with that one. In row 462, a name (e.g. hamburger) for the word or phrase can be entered, and in row 460 that name can be specified as Local or Global—a global name is placed in a Bind statement in the final template (not shown).

Buttons in row 464 enable a user to select other adjustments to the word, including “None,” “Plural,” “Past Tense,” “Possessive,” “Gerund,” “Singular,” “Comparative,” “Superlative” and “Capital.” Below row 464 in row 466 you can specify the synonym-network search diameter, which will override the default set in the Synonym Selection Pane for this word only.

The last pane (not shown) is for making connections between words. Variable words have checkboxes next to them, and the user may check any of them, then select the kinds of relation (e.g., Echo and Different), then either Submit (if you want to do more relation assignments) or Done & Submit to make the connections. In the example shown, the system tries try to make the words for “dogs” and “hogs” echo. You also can supply a bonus that applies to only the selected words and relation type. Note that words that have lost capitalization but are not marked for synonym selection will, generally, be fixed by the system later in the process.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the an to understand the invention for various embodiments with various modifications as arc suited to the particular use contemplated.

The flowchart and block diagrams in the Figures illustrate the architecture, functionality, and operation of possible implementations of systems, methods and computer program products according to various embodiments of the present invention. In this regard, each block, in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

We claim:

1. A method for tailoring correspondence based upon individual recipients, comprising:
receiving a correspondence for dissemination to a set of recipients;
annotating text within the composition to identify words and characteristics of the words;
identifying a customization criteria based upon a target audience:
generating a template, wherein the template comprises:
the customization criteria; and
modification constraints; and
applying the template and the customization criteria to the annotated text to generate a revised correspondence.

2. The method of claim 1, further comprising:
iteratively applying the template and the customization criteria to the annotated text to a generate plurality of additional revised correspondences;
ranking the revised correspondence and the plurality of additional revised correspondences;
selecting a subset of the revised correspondence and the plurality of additional revised correspondences based upon the ranking;
displaying a list of the subset in a graphical user interface for selection, by a user, of one or more of the subset.

3. The method of claim 1, further comprising transmitting the revised correspondence to the target audience.

4. The method of claim 1, further comprising:
applying, a second time, the template and the customization criteria to the annotated text to generate a second revised correspondence;
scoring the revised correspondence and the second revised correspondence to generate a ranking; and
selecting one of the revised correspondence and the second revised correspondence based upon the ranking;
transmitting the selected one of revised correspondence and the second revised correspondence to the target audience.

5. The method of claim 1, wherein the customization criteria is based upon the target audience in the set of recipients.

6. The method of claim 1, wherein the customization criteria is based upon a writing style of a writer of an example text.

7. The method of claim 1, wherein the customization criteria is based upon writing craft elements selected form a list, the list consisting of:
sounds of words;
rhythm;
orthographic properties; and
mood and sense-based influences.

8. The method of claim I wherein the template identities phrases in the correspondence with weighting by phrase for aspects selected from a group consisting of:
sameness
part of speech;
phonetic similarity;
semantic similarity;
mood;
repetition;
rhyme;
simplicity;
complexity;
demography;
age group;
importance; and
familiarity.

9. The method of claim 1, wherein the template is modularized to facilitate replacing the target audience.

10. An apparatus for tailoring correspondence based upon individual recipients, comprising:
a processor,
a computer-readable storage medium couple to the processor; and
instructions stored on the computer-readable storage medium and executed On the processor for performing a method, the method comprising:
receiving a correspondence for dissemination to a set of recipients;
annotating text within the composition to identify words and characteristics of the words;
identifying a customization criteria based upon a target audience generating a template, wherein the template comprises:
the customization criteria; and
modification constraints; and
applying the template and the customization criteria to the annotated text to generate a revised correspondence.

11. The apparatus of claim 10, the method further comprising:
iteratively applying the template and the customization criteria to the annotated text to a generate plurality of additional revised correspondences;
ranking the revised correspondence and the plurality of additional revised correspondences;
selecting a subset of the revised correspondence and the plurality of additional revised correspondences based upon the ranking;
displaying a list of the subset in a graphical user interface for selection, by a user, of one or more of the subset.

12. The apparatus of claim 10, the method further comprising transmitting the revised correspondence to the target audience.

13. The apparatus of claim 10, the method further comprising;
applying, a second time, the template and the customization criteria to the annotated text to generate a second revised correspondence;
scoring the revised correspondence and the second revised correspondence to generate a ranking; and
selecting one of the revised correspondence and the second revised correspondence based upon the ranking;
transmitting the selected one of revised correspondence and the second revised correspondence to the target audience.

14. The apparatus of claim 10, wherein the customization criteria is based upon the target audience in the set of recipients.

15. The apparatus of claim 10, wherein the customization criteria is based upon a writing style of a writer of an example text.

16. A computer programming product for tailoring correspondence based upon individual recipients, comprising a non-transitory computer-readable storage medium having program code embodied therewith, the program code executable by a plurality of processors to perform a method comprising:
receiving a correspondence for dissemination to a set of recipients;
annotating text within the composition to identify words and characteristics of the words;
identifying a customization criteria based upon a target audience;
generating a template, wherein the template comprises:
the customization criteria; and
modification constraints; and
applying the template and the customization criteria to the annotated text to generate as revised correspondence.

17. The computer programming product of claim 16, the method limiter comprising:
iteratively applying the template and the customization criteria to the annotated text to a generate plurality of additional revised. correspondences;
ranking the revised correspondence and the plurality of additional revised correspondences;
selecting a subset of the revised correspondence and the plurality of additional revised correspondences based upon the ranking;
displaying a list of the subset in a graphical user interface for selection, by a user, of one or more of the subset.

18. The computer programming product of claim 16, the method further comprising transmitting the revised correspondence to the target audience.

19. The computer programming product of claim 16, the method further comprising:
applying, a second time, the template and the customization criteria to the annotated text to generate a second revised correspondence;
scoring the revised correspondence and the second revised correspondence to generate a ranking; and
selecting one of the revised correspondence and the second revised correspondence based upon the ranking;
transmitting the selected one of revised correspondence and the second revised correspondence to the target audience.

20. The computer programming product of claim 16, wherein the customization criteria is based upon the target audience in the set of recipients.
